(19) United States
(12) Patent Application Publication
(10) Pub. No.: US 2016/0301785 A1
(43) Pub. Date: Oct. 13, 2016

(54) Protective Cover for Wireless Terminal Including Electronic Ink Display Element Technical Field

(71) Applicant: SONY CORPORATION, Tokyo, Tokyo (JP)

(72) Inventors: Andreas Espinoza, Lund (SE); Aleksandar Rodzevski, Lund (SE)

(21) Appl. No.: 15/037,535

(22) PCT Filed: Nov. 19, 2013
(86) PCT No.: PCT/IB2013/060248

§ 371 Date: May 18, 2016

(51) Int. Cl. H04M 1/02; H04B 1/3888; H02J 50/10; H02J 50/80; H02J 7/02; H04B 5/00; H04M 1/725

(52) U.S. Cl. CPC H04M 1/0283; H04B 5/0037; H04B 5/0075; H04B 1/3888; H04M 1/72577; H04M 1/72566; H02J 50/80; H02J 7/025; H02J 50/10; H04M 2250/04

(57) ABSTRACT

According to one aspect of the present disclosure, a method is performed by a protective cover for a wireless terminal. The protective cover includes a transceiver circuit, a processor circuit, an electronic ink display element, and an inductive power supply circuit. The inductive power supply circuit inductively charges from a wireless terminal contained in the protective cover, and supplies power to the transceiver circuit, the processor circuit, and the electronic ink display element. The transceiver circuit wirelessly receives data from the wireless terminal. The processor circuit updates the electronic ink display element based on the received data. The receiving and the updating are performed using the power from the inductive power supply circuit.

The present disclosure relates to a protective cover for a wireless terminal, and more particularly to a protective cover for a wireless terminal that includes an electronic ink display element.

### BACKGROUND

As wireless terminals and smartphones in particular become increasingly popular, users have come to rely on these devices to perform a wide variety of tasks. In many instances, smartphones have replaced wristwatches as a way to determine time and date. Some users frequently lookup information such as time and date without using any other smartphone features. That is, a user may activate the screen of their smartphone for no other reason than to check the time and/or date. Similarly, a user looking for additional information (e.g., weather, news headlines, a shopping list, etc.) may repeatedly activate their screen and unlock their phone for the sole purpose of accessing that information. Such frequent screen activations can be cumbersome for users, and can be demanding on the battery of the wireless terminal.

### SUMMARY

According to one aspect of the present disclosure, a method is implemented by a protective cover for a wireless terminal. The protective cover includes a transceiver circuit, a processor circuit, an electronic ink display element, and an inductive power supply circuit. The inductive power supply circuit inductively charges from a wireless terminal contained in the protective cover, and supplies power to the transceiver circuit, the processor circuit, and the electronic ink display element. The inductive charging and supplying of power are implemented by the inductive power supply circuit. The transceiver circuit wirelessly receives data from the wireless terminal. The processor circuit updates the electronic ink display element based on the received data. The receiving and the updating are performed using the power from the inductive power supply circuit.

According to another aspect of the present disclosure, a protective cover for a wireless terminal is disclosed. An inductive power supply circuit is disposed on the protective cover and is configured to inductively charge from a wireless terminal contained in the protective cover. An electronic ink display element is disposed on the protective cover. A transceiver circuit is disposed on the protective cover and is configured to wirelessly receive data from the wireless terminal using power from the inductive power supply circuit. A processor circuit is disposed on the protective cover, and is configured to use power from the inductive power supply circuit to control the transceiver circuit and the electronic ink display element, and to update the electronic ink display element based on the received data.

According to another aspect of the present disclosure, an electronic ink display assembly includes an adhesive layer that is disposed on a first side of a support member, with the support member being sized for mounting to a wireless terminal or to a protective cover for a wireless terminal. An inductive power supply circuit is secured to the support member, and is configured to inductively charge from the wireless terminal when the wireless terminal is contained in the protective cover. An electronic ink display element is disposed on an opposite second side of the support member. A transceiver circuit is secured to the support member and is configured to wirelessly receive data from the wireless terminal using power from the inductive power supply circuit. A processor circuit is secured to the support member, and is configured to use power from the inductive power supply circuit to control the transceiver circuit and the electronic ink display element, and to update the electronic ink display element based on the received data.

In one or more embodiments, the data received from the wireless terminal includes a current time, a current date, or both. In one or more embodiments, the inductive power supply circuit and the transceiver circuit are part of a Near Field Communication (NFC) tag. In one or more embodiments, the inductive power supply circuit and the transceiver circuit are part of a Wireless Charging tag.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIGS. 1A-B schematically illustrate an example protective cover for a wireless terminal that includes an electronic ink display element.

FIGS. 2A-B illustrate example embodiments of the protective cover of FIGS. 1A-B.

FIG. 3 is a flow diagram of an example method performed by a protective cover for a wireless terminal.

FIG. 4 illustrates a user interface for an example wireless terminal application for controlling updates to the electronic ink display element.

FIGS. 5A-B illustrates the main functional elements of a wireless terminal operative to provide updates to the electronic ink display element of the protective cover.

FIG. 6 illustrates an embodiment in which an electronic ink display element and associated circuitry is disposed on a support member having an adhesive layer for mounting to a protective cover for a wireless terminal.

### DETAILED DESCRIPTION

The present disclosure describes a protective cover 10 for a wireless terminal 12, with the protective cover including an electronic ink display element 14 operative to display data wirelessly received from the wireless terminal through, e.g., Near Field Communication (NFC) or Wireless Charging transmission(s) when the wireless terminal is in proximity to the protective cover (e.g., when the wireless terminal 12 is received into and contained in the protective cover 10). This provides a low power way to display information from the wireless terminal 12, such as time and date information, without requiring users to activate a display of the wireless terminal 12, and without requiring a wired connection between the protective cover 10 and the wireless terminal 12.

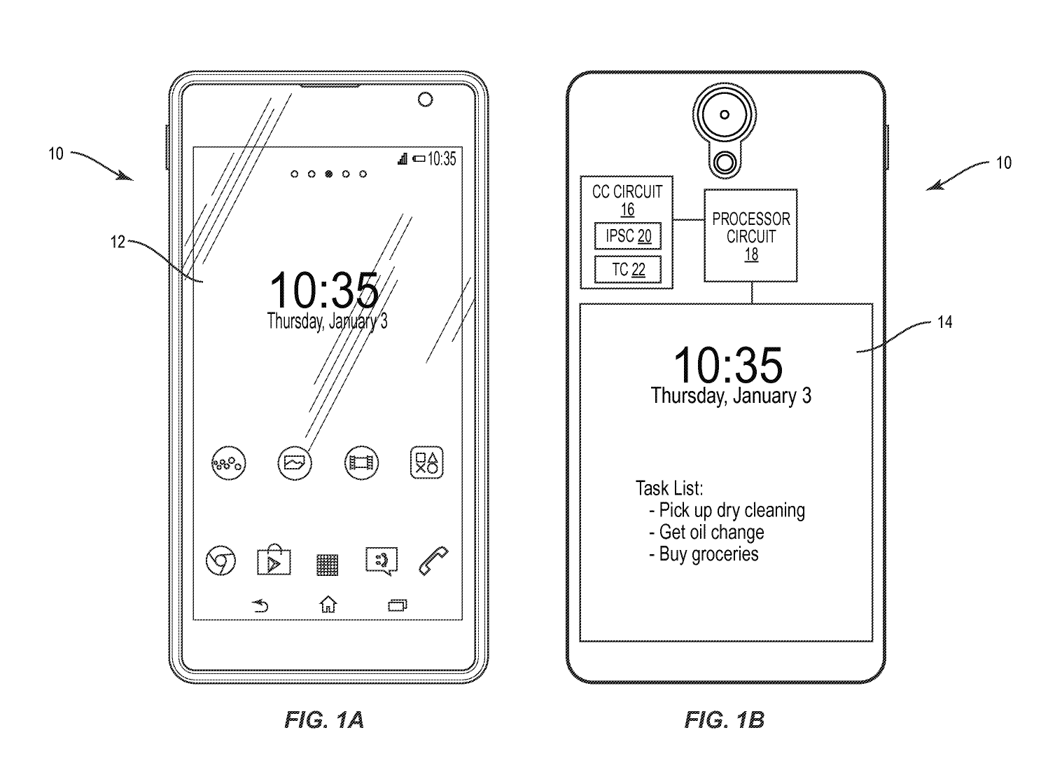

FIGS. 1A-B schematically illustrates an example protective cover 10 for a wireless terminal 12. The protective cover 10 includes an electronic ink display element 14 that is disposed on the protective cover 10. A charging and communication (CC) circuit 16 and a processor circuit 18 are also disposed on the protective cover 10. The CC circuit 16 includes an inductive power supply circuit 20 and a transceiver 20 that are, through their inclusion in the CC circuit 16, also disposed on the protective cover 10. To be “disposed on” the protective cover 10, the CC circuit 16 and processor circuit 18 could be either secured to an exterior of the protective cover 10, partially molded into the protective cover 10, or completely molded into the protective cover 10, for example. Similarly, to be “disposed on” the protective cover 10, the electronic ink display element 14 could be secured to the exterior of the protective cover 10, or could be partially molded into the protective 10 (i.e., so that at least a display area of the display element 14 is visible).

The inductive power supply circuit 20 is configured to inductively charge from the wireless terminal 12 when the wireless terminal 12 is contained in the protective cover 10. The transceiver circuit 22 is configured to wirelessly receive data from the wireless terminal 12 using power from the inductive power supply circuit 20. The processor circuit 18 is configured to use power from the inductive power supply circuit 20 to control the transceiver circuit 22 and the electronic ink display element 14, and to update the electronic ink display element 14 based on the received data. The transceiver circuit 22 and processor circuit 18 comprise one or more processor circuits, including, for example, one or more microprocessors, microcontrollers, digital signal processors, or the like, and, if necessary, are also each configured with appropriate software and/or firmware to carry out one or more of the techniques discussed above. For convenience, similar reference numerals are used throughout the Figures to indicate similar elements.

The wireless terminal 22 may be a cellular telephone, smartphone, personal digital assistant (PDA), tablet computer, laptop computer, laptop embedded equipment (LEE), laptop mounted equipment (LME), or any other device equipped with NFC and/or Wireless Charging features. Thus, although a smartphone is shown in FIG. 1A, it is understood that this is a non-limiting example.

Some electronic ink technologies (such as electrophoretic ink, also known as “E Ink”) are so-called “passive” displays that require electricity to alter what is displayed, but can then continue displaying that static content (e.g., text and/or images) indefinitely without requiring additional power. In this regard, passive electronic ink displays serve as a sort of non-volatile memory, because they consume power only when being updated, and subsequently retain data (i.e., the text and/or images being displayed). By using an electronic ink display element 14 that is passive, and by inductively charging from the wireless terminal 10 via the inductive power supply circuit 20, the protective cover 10 can be constructed without requiring a battery that would otherwise require frequent charging or replacement.

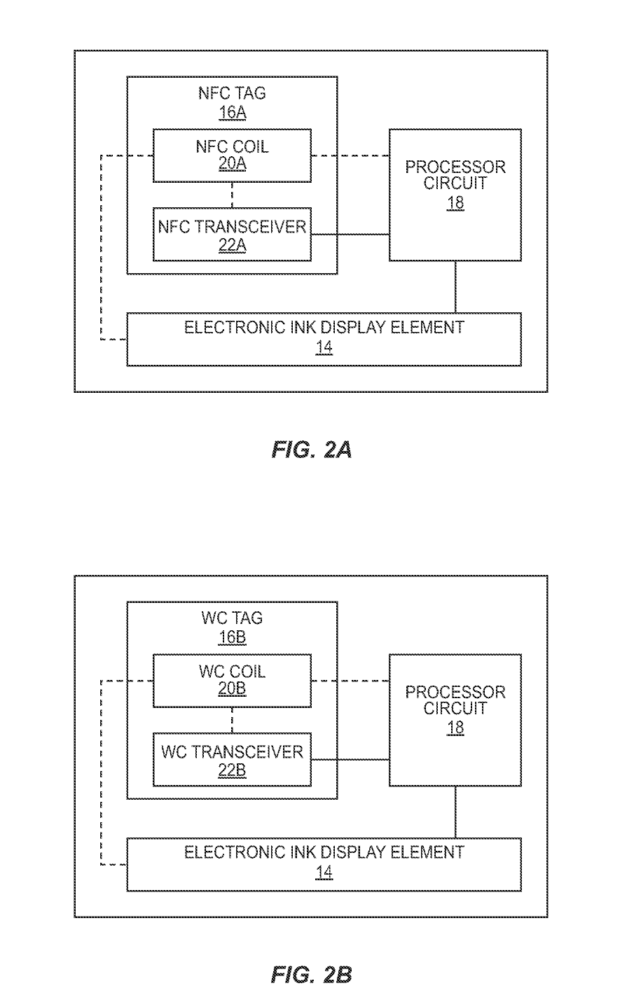

FIG. 2A illustrates an embodiment of the protective cover 10 that uses NFC. In this embodiment, the CC circuit 16 includes an NFC tag 16A, the inductive power supply circuit 20 includes an NFC coil 20A, and the transceiver circuit includes an NFC transceiver 22A. NFC is used to transmit data from the wireless terminal 12 to the protective cover 10.

FIG. 2B illustrates an embodiment of the protective cover 10 that uses Wireless Charging. In this application, “Wireless Charging” refers to a non-NFC standard for inductive charging and data transmission, such as the Qi standard from the Wireless Power Consortium (WPC), or a comparable standard from the Alliance for Wireless Power (A4WP). In the embodiment of FIG. 2B, CC circuit 16 is a Wireless Charging tag 16B, the inductive power supply circuit 20 includes a Wireless Charging coil 20B, and the transceiver circuit includes a Wireless Charging transceiver 22B.

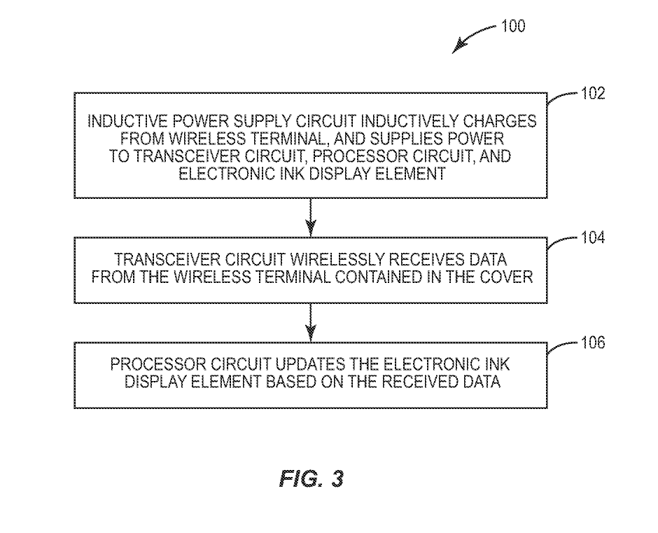

FIG. 3 is a flow diagram of an example method 100 performed by the protective cover 10 for wireless terminal 12. The inductive power supply circuit 20 inductively charges from a wireless terminal 12 contained in the protective cover 10, and supplies power to the transceiver circuit 22, the processor circuit 18, and the electronic ink display element 14 (block 102). The transceiver circuit 22 wirelessly receives (block 104) data from the wireless terminal 12 contained in the protective cover 10. The processor circuit 18 updates (block 106) the electronic ink display element 14 based on the received data. The receiving (block 104) and updating (block 106) are performed using the power from the inductive power supply circuit (20) (e.g., through NFC or Wireless Charging).

An application on the wireless terminal 10 provides users with the ability to verify a communication link to the electronic ink display element 14, and to control what is displayed on the electronic ink display element 14. For example, a user could use the application to control what content they want displayed on the electronic ink display element 14. Optionally, users could also choose how often they want that content updated. For example, a user could choose how often they wanted weather updates to be sent to the electronic ink display element 14. Default update periods could be set based on what content is being displayed (e.g., every minute if time and date are displayed, or once a day if date is displayed without time). If items with differing update periods are chosen, in one or more embodiments both types of content are updated based on the shorter of those periods (e.g., if updates for “time” are scheduled every minute, update other content every minute as well, even if the other content would otherwise have a longer update period).

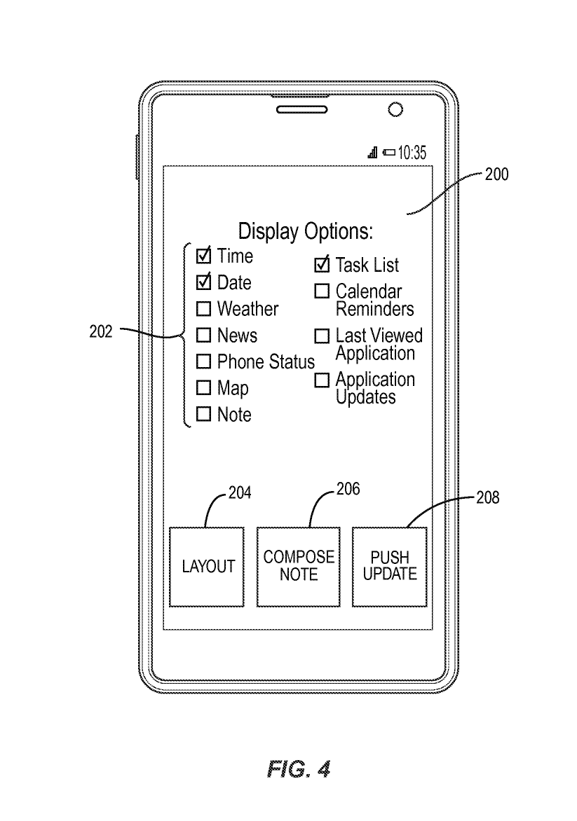

FIG. 4 illustrates an example user interface 200 for a wireless terminal application. As shown in FIG. 4, a number of display items 202 are available for selection (e.g., through checkboxes), such that a user can select which of the display items they want shown on the electronic ink display element 14 of the protective cover 10. A number of example display items 202 are shown in FIG. 4. These include time, date, weather, news, phone status (e.g., missed calls, received SMS messages, etc.), a map, and a note. In one or more embodiments the “note” display item corresponds to a free text/sketching screen where a user can use an input (e.g., their finger, a keypad, and/or a stylus) to draw, sketch, and/or write a note. A corresponding “compose note” button 206 could be selected to compose such a note.

Other example display items 202 shown in FIG. 4 include a task list (e.g., a list of errands to complete and/or a grocery list), calendar reminders (e.g., meeting reminders from a calendar application such as MICROSOFT OUTLOOK), a last viewed application, and application updates. The “last viewed application” display item corresponds to a last active application displayed on the wireless terminal 10 prior to shutoff of the main display of the wireless terminal. Thus, in various embodiments a user could use the “last viewed application” display item to view any of the following items on the electronic ink display element 14: a desktop clock, a map, some text (e.g., from a web browser), a photo, an email, a song being played by a music application, etc.

In one or more embodiments, the “application updates” correspond to updates from other applications on the wireless terminal (e.g., games, social media applications, Short Message Service “SMS” messages, etc.). In one or more embodiments these are application updates that would otherwise be pushed to the display of the wireless terminal 12 and would otherwise cause the wireless terminal 12 display to turn ON from an OFF state. In one or more embodiments, selecting the “application updates” display item redirects these updates from the main display of the wireless terminal 12 to the electronic ink display element 14, such that the main display of the wireless terminal 12 remains in the OFF state.

A “push update” button 208 enables a user of the application 200 to transmit an update to the electronic ink display element 14 on demand instead of waiting for a next scheduled update. For example, if the application of FIG. 4 is configured to only update once per hour, a user who has just composed a note may wish to immediately update the electronic ink display element 14 to display the note without waiting for the remainder of a current hour to transpire. A layout option 204 is also available, and is selectable so that the user can change the layout of how the various display items are shown on the display element 14, and optionally other layout aspects, such as font type and size. In one example, branding could be displayed as a default option (e.g., network operator branding, wireless terminal manufacturer branding, and/or protective cover manufacturer branding) unless disabled by the user.

Thus, in one or more embodiments the processor circuit 18 updates the electronic ink display element 14 periodically based on the transceiver circuit 22 receiving data from the wireless terminal 12 periodically according to a predefined update schedule (e.g., one update per minute), updates the electronic ink display element 14 based on the transceiver circuit 22 receiving data from the wireless terminal 12 when requested by a user of the wireless terminal 12 outside of the update schedule (e.g., through button 208), or both.

As shown in FIG. 4, the “time”, “date”, and “task list” display items are selected. Thus, the data received from the wireless terminal 12 can include a current time, a current date, or both. An example presentation of these display items is shown in FIG. 1B, where the task list includes the time, the date, and the tasks of “pick up dry cleaning,” “get oil change,” and “buy groceries.” By displaying the time, the electronic ink display element 14 could serve as an “always on” clock that updates periodically (e.g., once per minute) when in proximity to the wireless terminal 12 (e.g., when the wireless terminal 12 is contained in the protective cover 10) while only using a very small amount of power from the wireless terminal 12, through use of the inductive power supply circuit 20.

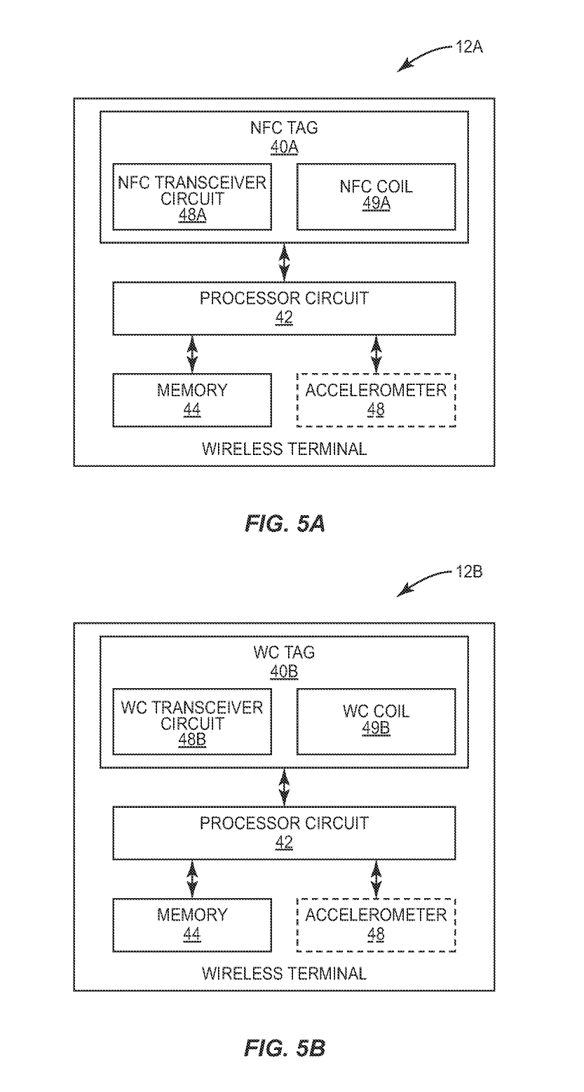

FIGS. 5A-B illustrate embodiments of main functional elements of a wireless terminal 12 operative to provide updates to the electronic ink display element 14. In the embodiment of FIG. 5A, the wireless terminal 12A includes an NFC tag 40A, a processor circuit 42, a processor circuit 42, memory 44, and optionally an accelerometer 46. The NFC tag 40A includes an NFC transceiver circuit 48A and an NFC coil 49A. The NFC transceiver 48A is operative to communicate with NFC transceiver 22A of the protective cover 10 (see FIG. 2A). The processor circuit 42 is operative to execute a software application for controlling what is sent via the NFC transceiver 48 to the electronic ink display element 14 (e.g., utilizing the user interface of FIG. 4). The NFC transceiver 48A and processor circuit 42 each comprise one or more processor circuits, including, for example, one or more microprocessors, microcontrollers, digital signal processors, or the like, and, if necessary, are also each configured with appropriate software and/or firmware to carry out one or more of the techniques discussed above.

The memory 44 is operative to store the software application of FIG. 4 (e.g., as a dedicated application, or as a cached application downloaded through a web browser). NFC coil 49A is operative to inductively charge the NFC coil 20A of the protective cover 10 (see FIG. 2A) when the wireless terminal 12 is contained in the protective cover 10 or is in close proximity to the protective cover 10 (e.g., 10 centimeters or less). In one or more embodiments, the processor circuit 42 is configured to periodically transmit updates to the electronic ink display element 14 periodically at a predefined time interval. The optional accelerometer 46 can be used to detect movement of the wireless terminal 12 (e.g., removal from a pocket or purse) and/or vibration of the wireless terminal 12, and can use that detected movement as a trigger to push an update to the electronic ink display element 14 even if a next periodic update is not yet scheduled to occur.

FIG. 5B illustrates a similar wireless terminal 12B which uses Wireless Charging instead of using NFC. Thus, the wireless terminal 12B includes a Wireless Charging tag 40B that includes a Wireless Charging transceiver circuit 48B and a Wireless Charging coil 49B operative to communicate with the Wireless Charging tag 16B of FIG. 2B. Otherwise, the wireless terminal 12B is configured as described above.

As shown in FIGS. 1A-B, the sides and back of the wireless terminal are substantially covered by the protective cover 10, and the front of the wireless terminal 12 is also partially covered by the protective cover 10. In this embodiment, the electronic ink display element 14 is disposed on a first side of the protective cover 10 (i.e., the backside) and displays information received from the processor circuit 18 on the first side of the protective cover 10, and the protective cover 10 is operative to removably receive the wireless terminal 12 on an opposite second side (i.e., the front side) of the protective cover 10.

In one or more embodiments, the components 14, 16, 18, 20, 22 are molded into the protective cover 10, such that a user would not see the NFC transceiver 16, processor circuit 18, and inductive power supply circuit 20, and would not see some or all of the sides of the electronic ink display element (as only the front of the display element 14 would be visible). In this regard, the components 14, 16, 18, 20, 22 being disposed “on” the protective cover 10 encompasses one or more of these components being partially or entirely enclosed within the protective cover 10 (e.g., embedded into the protective cover and hidden from view). Of course, the components 14, 16, 18, and 20 could be presented in other configurations and could be integrated into or mounted on other protective covers than that shown in FIGS. 1A-B.

In one or more embodiments, the placement of the CC circuit 16 is chosen to place the inductive power supply circuit 20 and transceiver circuit 22 in an optimal proximity to the corresponding transceiver circuit 48 and coil 49 of the wireless terminal 12, and to avoid an unnecessary distance between these components (e.g., placing the coil 49 and inductive power supply circuit 20 at opposite corners of the protective cover 10, or placing the transceiver circuits 22 and 48 at opposite corners of the protective cover 10).

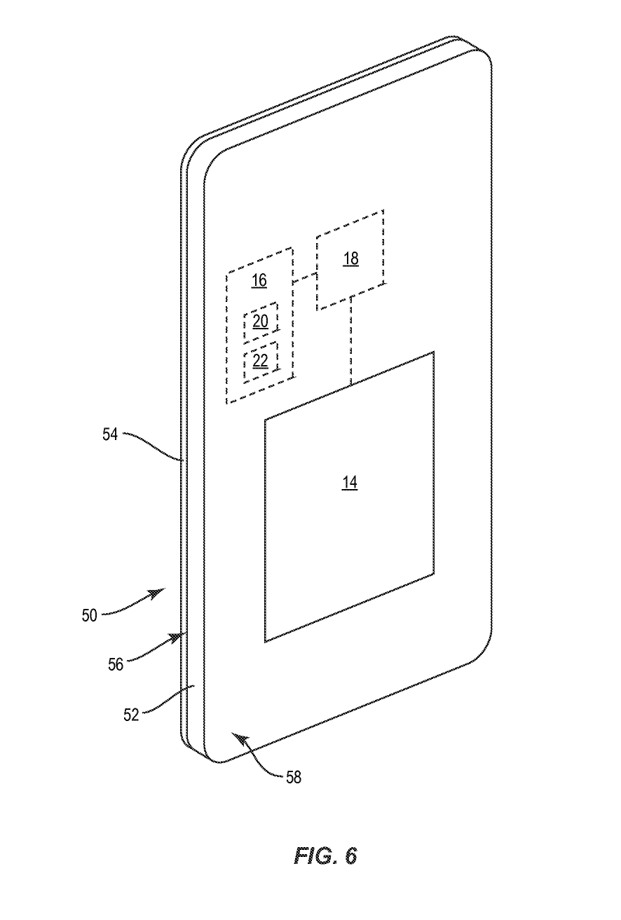

FIG. 6 illustrates an embodiment utilizing an adhesive backed electronic ink display assembly 50 in which the electronic ink display element 14 and its associated components 16, 18, 20, 22 are disposed on a support member 52 that is sized for mounting to a wireless terminal 12 or to a protective cover 10 for a wireless terminal 12. The assembly 50 includes adhesive layer 54 disposed on a first side 56 of the support member 52, for mounting the support member 52 to the protective cover 10. Inductive power supply circuit 20 is secured to the support member 52, and is configured to inductively charge from the wireless terminal 12 when the wireless terminal 12 is contained in the protective cover 10. Electronic ink display element 14 is disposed on an opposite second side 58 of the support member 52. Transceiver circuit 22 is secured to the support member 52 and is configured to wirelessly receive data from the wireless terminal 12 using power from the inductive power supply circuit 18. Processor circuit 18 is secured to the support member 52, and is configured to use power from the inductive power supply circuit 20 to control the transceiver circuit 22 and the electronic ink display element 14, and to update the electronic ink display element 14 based on the received data. The items 16, 18, 20, 22 are shown with dotted lines, because it is understood that they may be molded into the support member 52 and not visible when viewing the second side 58 of the assembly 50.

In one or more embodiments, the assembly 50 could be applied as an after-market product to any number of wireless terminal protective cases (for example, instead of being affixed to and/or integrated into a specific protective cover prior to sale of the protective cover). In one or more embodiments the support member 52 has a generally planar structure, but is flexible to accommodate rounded protective covers of various protective cases. In one or more embodiments, the assembly 50 could be applied directly to a wireless terminal 12 that does not use a protective cover 10. In one or more embodiments (e.g., that of FIGS. 1A-B), the electronic ink display element 14 is flexible and permits bending about rounded surfaces (e.g., rounded protective covers and/or rounded wireless terminals). In one or more embodiments, the protective cover includes both an NFC tag 16A and a Wireless Charging tab 16B such that both NFC and Wireless Charging are supported.

Because many users opt to place their valuable smart phones, tablets, and other such wireless terminals in a protective cover, the embodiments described above have wide applicability for saving power of such wireless terminals that would otherwise be consumed by users activating the displays of their wireless terminals to repetitively determine pieces of information (e.g., time, date, etc.). By using a passive display as described above, the protective cover 10 would use very little power, and could charge from a given wireless terminal 12 when the wireless terminal 12 is in proximity to the inductive power supply circuit 20 (e.g., when the wireless terminal 12 is contained in the protective cover 10), thus avoiding the need for an independent power supply and a wired connection between the protective cover 10 and the wireless terminal 12.

The foregoing description and the accompanying drawings represent non-limiting examples of the methods and apparatus taught herein. As such, the present disclosure is not limited by the foregoing description and accompanying drawings. Instead, the present disclosure is limited only by the following claims and their legal equivalents.

1-17. (canceled)

18. A method implemented by a protective cover for a wireless terminal, the protective cover including a transceiver circuit, a processor circuit, an electronic ink display element, and an inductive power supply circuit, the method comprising:
inductively charging from a wireless terminal contained in the protective cover, and supplying power to the transceiver circuit, the processor circuit, and the electronic ink display element, wherein the inductive charging and supplying of power are implemented by the inductive power supply circuit;
wirelessly receiving, by the transceiver circuit, data from the wireless terminal; and updating, via the processor circuit, the electronic ink display element based on the received data;
wherein the receiving and the updating are performed using the power from the inductive power supply circuit.

19. The method of claim 18:
wherein the inductive power supply circuit and the transceiver circuit are part of a Near Field Communication (NFC) tag; and
wherein the inductive charging and receiving of data from the wireless terminal are performed using NFC.

20. The method of claim 18:
wherein the inductive charging from the wireless terminal is performed using Wireless Charging; and
wherein the receiving of data from the wireless terminal is performed using a Wireless Charging communication protocol.

21. The method of claim 18, wherein the protective cover includes a first side and an opposite second side, the method comprising:
removably receiving the wireless terminal on the second side of the protective cover to facilitate the inductive charging and the receiving of the wireless transmission of data;
wherein updating the electronic ink display element based on the received data comprises displaying, via the electronic ink display element and on the first side of the protective cover, information received from the processor circuit.

22. The method of claim 18, wherein the processor circuit updates the electronic ink display element periodically based on the transceiver circuit receiving data from the wireless terminal periodically according to a predefined update schedule, updates the electronic ink display element based on the transceiver circuit receiving data from the wireless terminal when requested by a user of the wireless terminal outside of the update schedule, or both.

23. The method of claim 18, wherein the data received from the wireless terminal includes a current time, a current date, or both.

24. A protective cover for a wireless terminal comprising:
an inductive power supply circuit disposed on the protective cover and configured to inductively charge from a wireless terminal contained in the protective cover;
an electronic ink display element disposed on the protective cover;
a transceiver circuit disposed on the protective cover and configured to wirelessly receive data from the wireless terminal using power from the inductive power supply circuit; and
a processor circuit disposed on the protective cover, and configured to use power from the inductive power supply circuit to control the transceiver circuit and the electronic ink display element, and to update the electronic ink display element based on the received data.

25. The protective cover of claim 24:
wherein the inductive power supply circuit and the transceiver circuit are part of a Near Field Communication (NFC) tag;
wherein the inductive power supply circuit is configured to inductively charge from the wireless terminal using NFC; and
wherein the transceiver circuit is configured to receive the data from the wireless terminal using NFC.

26. The protective cover of claim 24:
wherein the inductive power supply circuit and the transceiver circuit are part of a Wireless Charging tag;
wherein the inductive power supply circuit is configured to inductively charge from the wireless terminal using Wireless Charging; and
wherein the transceiver circuit is configured to receive the data from the wireless terminal using a Wireless Charging communication protocol.

27. The protective cover of claim 24, wherein the electronic ink display element is disposed on a first side of the protective cover, and wherein the protective cover is operative to removably receive the wireless terminal on an opposite second side of the protective cover.

28. The protective cover of claim 24, wherein the processor circuit is configured to update the electronic ink display element periodically based on the transceiver circuit receiving data from the wireless terminal periodically according to a predefined update schedule, to update the electronic ink display element based on the transceiver circuit receiving data from the wireless terminal when requested by a user of the wireless terminal outside of the update schedule, or both.

29. The protective cover of claim 24, wherein the data received from the wireless terminal includes a current time, a current date, or both.

30. An electronic ink display assembly comprising:
an adhesive layer disposed on a first side of a support member, the support member being sized for mounting to a wireless terminal or to a protective cover for a wireless terminal;
an inductive power supply circuit secured to the support member, and configured to inductively charge from the wireless terminal when the wireless terminal is contained in the protective cover;
an electronic ink display element disposed on an opposite second side of the support member;
a transceiver circuit secured to the support member and configured to wirelessly receive data from the wireless terminal using power from the inductive power supply circuit; and
a processor circuit secured to the support member, and configured to use power from the inductive power supply circuit to control the transceiver circuit and the electronic ink display element, and to update the electronic ink display element based on the received data.

31. The electronic ink display assembly of claim 30:
wherein the inductive power supply circuit and the transceiver circuit are part of a Near Field Communication (NFC) tag;
wherein the inductive power supply circuit is configured to inductively charge from the wireless terminal using NFC; and
wherein the transceiver circuit is configured to receive the data from the wireless terminal using NFC.

32. The electronic ink display assembly of claim 30:
wherein the inductive power supply circuit and the transceiver circuit are part of a Wireless Charging tag;
wherein the inductive power supply circuit is configured to inductively charge from the wireless terminal using Wireless Charging; and
wherein the transceiver circuit is configured to receive the data from the wireless terminal (12) using a Wireless Charging communication protocol.

33. The electronic ink display assembly of claim 30, wherein the processor circuit is configured to update the electronic ink display element periodically based on the transceiver circuit receiving data from the wireless terminal periodically according to a predefined update schedule, to update the electronic ink display element based on the transceiver circuit receiving data from the wireless terminal when requested by a user of the wireless terminal outside of the update schedule, or both.

34. The electronic ink display assembly of claim 30, wherein the data received from the wireless terminal includes a current time, a current date, or both.
